(19) United States
(12) Patent Application Publication
(10) Pub. No.: US 2003/0171244 A1
(43) Pub. Date: Sep. 11, 2003

(54) Detergent compositions and processes for preparing the same

(76) Inventors: Karl Heinz Schmid, Mettmann (DE); Detlev Stanislowski, Mettmann (DE); Andreas Syldath, Monheim (DE); Rainer Eskuchen, Langenfeld (DE)

Correspondence Address: COGNIS CORPORATION, 2500 RENAISSANCE BLVD., SUITE 200, GULPH MILLS, PA, 19406

(21) Appl. No.: 10/325,397

(22) Filed: Dec. 19, 2002

(30) Foreign Application Priority Data
Dec. 21, 2001 (DE) 101 63 281.9

(51) Int. Cl. C11D 17/00

(52) U.S. Cl. 510/421; 510/446

(57) ABSTRACT

Detersive preparations containing solid granular nonionic surfactants and to their use in detersive preparations, and more particularly, to detersive preparations which at least contain granules of a nonionic surfactant solid at room temperature and at least one anionic surfactant; are disclosed.

### BACKGROUND OF THE INVENTION

Nonionic surfactants, for example alkyl oligoglucosides, are distinguished by excellent detergent properties and high ecotoxicological compatibility. Because of this, these classes of nonionic surfactants are acquiring increasing significance. As they have hitherto generally been used in liquid formulations, such as dishwashing detergents or hair shampoos for example, there is also a considerable demand on the market for water-free supply forms which can also be incorporated, for example, in solid detergents.

Detergents in the present context are understood to be not only powder-form or granular detergents, but also and above all detergents in the form of shaped bodies, such as tablets. In their case in particular, it has been found that, by using nonionic surfactant granules on solid supports, migration or penetration of the nonionic surfactant into other constituents of the detergent tablet, for example into the so-called “disintegrator” component, can be avoided whereas, with conventional production where the nonionic surfactant is distributed by spraying over the entire detergent powder before it is tabletted, the nonionic surfactant penetrates into the “disintegrator” which thus loses its effectiveness so that the rapid disintegration of the tablet at the beginning of the washing process is delayed or prevented altogether.

Among detergent manufacturers, the solid water-free nonionic surfactants can only be used if they can readily be incorporated during the production of detergents and cosmetic products. It is therefore essential that the solid water-free nonionic surfactants show good flow behavior so that they can be handled in hopper trucks or big bags. The solid water-free nonionic surfactants also have to be dust-free so that there is no risk of dust explosions during their processing and the processor is not in any danger of health damage, for example by inhalation of surfactant dusts.

On an industrial scale, liquid surfactant preparations are generally produced by conventional spray drying in which the water-containing surfactant paste is sprayed at the head of a spray drying tower in the form of fine droplets which encounter hot drying gases flowing in countercurrent. German patent application DE-A1 41 02 745 (Henkel), for example, describes a process in which a small quantity (1 to 5% by weight) of alkyl glucosides is added to fatty alcohol pastes which are then subjected to conventional spray drying. Unfortunately, the process can only be carried out in the presence of a large quantity of inorganic salts. According to German patent application DE-A1 41 39 551 (Henkel), pastes of alkyl sulfates and alkyl glucosides, which may only contain at most 50% by weight of the sugar surfactant, are sprayed in the presence of mixtures of soda and zeolites. However, this only gives compounds which have a low surfactant concentration and an inadequate bulk density. Finally, International patent application WO 95/14519 (Henkel) describes a process in which sugar surfactant pastes are subjected to drying with superheated steam.

Basically, the introduction of nonionic surfactants into detersive compositions is attended by the problem that the surfactants—which are normally liquid at room temperature—migrate within the detersive compositions and enter into unwanted interactions with other ingredients, for example with defoamers or disintegrators.

Unfortunately, the processes mentioned are also technically very complicated. Accordingly, one problem addressed by the present invention was to provide a simple process for the production of nonionic surfactant granules which would not require the presence of organic or inorganic support materials, such as soda, zeolites, inorganic salts or polymeric supports. In addition, it would be possible by this process to obtain granules which would be distinguished by high surfactant contents, high bulk densities and by good color quality and which at the same time would be dust-free, free-flowing and stable in storage.

Basically, the introduction of nonionic surfactants into detersive compositions is attended by the problem that the surfactants—which are normally liquid at room temperature—migrate within the detersive compositions and enter into unwanted interactions with other ingredients, for example with defoamers or disintegrators.

In addition, attempts have already been made to prevent the migration of nonionic surfactants in detergents by immobilization of the liquid nonionic surfactants on carrier materials. The disadvantage of this is that immobilization on carriers is generally a complicated procedure.

Another disadvantage of the surfactants known from the prior art is often that the production of detergents in the form of shaped bodies, especially tablets, often requires intensive compression.

Accordingly, the problem addressed by the present invention was to provide detersive preparations which would be attended by the disadvantages known from the prior art to only a reduced extent, if at all.

### SUMMARY OF THE INVENTION

Accordingly, the present invention relates, in general, to detersive preparations containing solid granular nonionic surfactants and to their use in detersive preparations, and more particularly, to detersive preparations which at least contain granules of a nonionic surfactant solid at room temperature and at least one anionic surfactant.

In the context of the invention, a nonionic surfactant “solid at room temperature” is understood to be a surfactant which has a softening point or a melting point above about 35° C. and preferably above 40° C. or 45° C.

Nonionic surfactants suitable for the purposes of the present invention are, for example, alkyl and alkenyl oligoglycosides, fatty acid-N-alkyl polyhydroxyalkylamides, alcohol alkoxylates, alkoxylated carboxylic acid esters, preferably alkyl and alkenyl oligloglycosides.

### DETAILED DESCRIPTION OF THE INVENTION

Alkyl and alkenyl oligoglycosides are known nonionic surfactants which correspond to formula (I):

RO-[G]_{z} (I)

where R is an alkyl and/or alkenyl group containing 4 to 22 carbon atoms, G is a sugar unit containing 5 or 6 carbon atoms and z is a number of 1 to 10. They may be obtained by the relevant methods of preparative organic chemistry. The overviews presented by Biermann al. in Starch/Stärke 45, 281 (1993), by B. Salka in Cosm. Toil. 108, 89 (1993) and by J. Kahre in SÖFW-Journal No. 8, 598 (1995) are cited as representative of the extensive literature available on this subject.

The alkyl and/or alkenyl oligoglycosides may be derived from aldoses or ketoses containing 5 or 6 carbon atoms, preferably glucose. Accordingly, the preferred alkyl and/or alkenyl oligoglycosides are alkyl and/or alkenyl oligoglucosides. The index z in general formula (I) indicates the degree of oligomerization (DP), i.e. the distribution of mono- and oligoglycosides, and is a number of 1 to 10. Whereas p in a given compound must always be an integer and, above all, may assume a value of 1 to 6, the value p for a certain alkyl oligoglycoside is an analytically determined calculated quantity which is generally a broken number.

Alkyl and/or alkenyl oligoglycosides having an average degree of oligomerization z of 1.1 to 3.0 are preferably used. Alkyl and/or alkenyl oligoglycosides having a degree of oligomerization of less than 1.7 and, more particularly, between 1.2 and 1.6 are preferred from the applicational point of view. The alkyl or alkenyl radical R may be derived from primary alcohols containing 4 to 11 and preferably 8 to 10 carbon atoms. Typical examples are butanol, caproic alcohol, caprylic alcohol, capric alcohol and undecyl alcohol and the technical mixtures thereof obtained, for example, in the hydrogenation of technical fatty acid methyl esters or in the hydrogenation of aldehydes from Roelen's oxosynthesis. Alkyl oligoglucosides having a chain length of C₈ to C₁₀ (DP=1 to 3), which are obtained as first runnings in the separation of technical C₈₋₁₂ coconut oil fatty alcohol by distillation, and also alkyl oligoglucosides based on technical C_{9/11}, C_{12/13} and C_{12/15} oxoalcohols (DP=1 to 3) are preferred.

The technical oxoalcohols marketed by Shell under the names of Dobanol® and Neodol® are particularly preferred in this regard. In addition, the alkyl or alkenyl radical R may also be derived from primary alcohols containing 12 to 22 and preferably 12 to 18 carbon atoms. Typical examples are lauryl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, brassidyl alcohol and technical mixtures thereof which may be obtained as described above. Alkyl oligoglucosides based on hydrogenated C_{12/14} coconut oil or palm kernel oil fatty alcohol or C_{12/14} fatty alcohol from coconut, palm kernel or palm oil having a DP of 1 to 3 are preferred.

Another class of suitable nonionic surfactants which may be used either as sole nonionic surfactant or in combination with other nonionic surfactants are alkoxylated, preferably ethoxylated or ethoxylated and propoxylated, fatty acid alkyl esters preferably containing 1 to 4 carbon atoms in the alkyl chain, more especially the fatty acid methyl esters which are described, for example, in Japanese patent application JP 58/217598 or which are preferably produced by the process described in International patent application WO-A-90/13533.

Nonionic surfactants of the amine oxide type, for example N-coconutalkyl-N,N-dimethylamine oxide and N-tallowalkyl-N,N-dihydroxyethylamine oxide, and the fatty acid alkanolamide type are also suitable.

Other suitable nonionic surfactants are polyhydroxyfatty acid amides corresponding to formula (II):

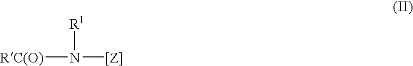

in which R′CO is an aliphatic acyl group containing 6 to 22 carbon atoms, R¹ is hydrogen, an alkyl or hydroxyalkyl group containing 1 to 4 carbon atoms and [Z] is a linear or branched polyhydroxyalkyl group containing 3 to 10 carbon atoms and 3 to 10 hydroxyl groups. The polyhydroxyfatty acid amides are known substances which may normally be obtained by reductive amination of a reducing sugar with ammonia, an alkylamine or an alkanolamine and subsequent acylation with a fatty acid, a fatty acid alkyl ester or a fatty acid chloride.

The group of polyhydroxyfatty acid amides also includes compounds corresponding to formula (III):

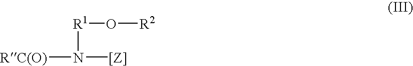

in which R″ is a linear or branched alkyl or alkenyl group containing 7 to 12 carbon atoms, R² is a linear, branched or cyclic alkyl group or an aryl group containing 2 to 8 carbon atoms and R is a linear, branched or cyclic alkyl group or an aryl group or an oxyalkyl group containing 1 to 8 carbon atoms, C₁₋₄ alkyl or phenyl groups being preferred, and [Z] is a linear polyhydroxyalkyl group, of which the alkyl chain is substituted by at least two hydroxyl groups, or alkoxylated, preferably ethoxylated or propoxylated, derivatives of that group.

[Z] is preferably obtained by reductive amination of a reduced sugar, for example glucose, fructose, maltose, lactose, galactose, mannose or xylose. The N-alkoxy- or N-aryloxy-substituted compounds may then be converted into the required polyhydroxyfatty acid amides by reaction with fatty acid methyl esters in the presence of an alkoxide as catalyst, for example in accordance with the teaching of International patent application WO-A-95/07331.

The polyhydroxyfatty acid amides are known compounds which may normally be obtained by reductive amination of a reducing sugar with an alkylamine or an alkanolamine and subsequent acylation with a fatty acid, a fatty acid alkyl ester or a fatty acid chloride. Processes for their production are described in U.S. Pat. No. 1,985,424, in U.S. Pat. No. 2,016,962 and in U.S. Pat. No. 2,703,798 and in International patent application WO 92/06984. An overview of this subject by H. Kelkenberg can be found in Tens. Surf. Det. 25, 8 (1988).

The use of fatty acid-N-alkyl polyhydroxyalkylamides is also the subject of a number of publications. For example, their use as thickeners is known from European patent application EP 0 285 768 A1 (Hüls). FR 1 580 491 A (Henkel) describes water-containing detergent mixtures based on sulfates and/or sulfonates, nonionic surfactants and optionally soaps which contain fatty acid-N-alkyl glucamides as foam regulators. Mixtures of short-chain and relatively long-chain glucamides are described in DE 44 00 632 C1 (Henkel). In addition, DE 42 36 958 A1 and DE 43 09 567 A1 (Henkel) report on the use of glucamides with relatively long alkyl chains as pseudoceramides in skin-care formulations and on combinations of glucamides with protein hydrolyzates and cationic surfactants in hair-care products. International patent applications WO 92/06153; WO 92/06156; WO 92/06157; WO 92/06158; WO 92/06159 and WO 92/06160 (Procter & Gamble) describe mixtures of fatty acid-N-alkyl glucamides with anionic surfactants, surfactants of sulfate and/or sulfonate structure, ether carboxylic acids, ether sulfates, methyl ester sulfonates and nonionic surfactants. The use of these substances in various laundry detergents, dishwashing detergents and cleaning products is described in International patent applications WO 92/06152; WO 92/06154; WO 92/06155; WO 92/06161; WO 92/06162; WO 92/06164; WO 92/06170; WO 92/06171 and WO 92/06172 (Procter & Gamble).

Alcohol ethoxylates may also be used as nonionic surfactants. Alcohol ethoxylates are known as fatty alcohol or oxoalcohol ethoxylates from their production and preferably correspond to the formula (IV):

R′″—O(CH₂CH₂O)ₙH (IV)

in which R′″ is a linear or branched alkyl and/or alkenyl group containing 6 to 22 carbon atoms and n is a number of 1 to 50. Typical examples are the adducts of on average 1 to 50, preferably 5 to 40 and more particularly 10 to 25 mol caproic alcohol, caprylic alcohol, 2-ethylhexyl alcohol, capric alcohol, lauryl alcohol, isotridecyl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol and brassidyl alcohol and the technical mixtures thereof obtained, for example, in the high-pressure hydrogenation of technical methyl esters based on fats and oils or aldehydes from Roelen's oxosynthesis and as monomer fraction in the dimerization of unsaturated fatty alcohols. Adducts of 10 to 40 mol ethylene oxide with technical C₁₂₋₁₈ fatty alcohols, for example coconut oil, palm oil, palm kernel oil or tallow fatty alcohol, are preferred.

Alkoxylated carboxylic acid esters may also be used as nonionic surfactants. Such compounds are known from the prior art. They may be obtained, for example, by esterification of alkoxylated carboxylic acids with alcohols. For the purposes of the present invention, however, the compounds are preferably produced by reaction of carboxylic acid esters with alkylene oxides using catalysts, more especially calcined hydrotalcite in accordance with DE-A-3914131 A, which give compounds with a narrow homolog distribution. Carboxylic acid esters of both monohydric alcohols and polyhydric alcohols can be alkoxylated by this process. Alkoxylated carboxylic acid esters of monohydric alcohols corresponding to general formula (V):

R⁴CO(OAlk)ₙOR⁵ (V)

in which R⁴CO is an aliphatic acyl group derived from a carboxylic acid, OAlk stands for alkylene oxide and R⁵ is an aliphatic alkyl group derived from a monohydric aliphatic alcohol, are preferred for the purposes of the invention. Alkoxylated carboxylic acid esters of formula (V), in which R⁴CO is an aliphatic acyl group containing 6 to 30, preferably 6 to 22 and more particularly 10 to 18 carbon atoms, OAlk stands for a CH₂CH₂O—, CHCH₃CH₂O— and/or CHₙ—CHCH₂O group, n has an average value of 1 to 30, preferably 5 to 20 and more particularly 10 to 15 and R⁵ is an aliphatic alkyl group containing 1 to 4 and preferably 1 and/or 2 carbon atoms, more particularly methyl, are particularly suitable. Preferred acyl groups are derived from carboxylic acids containing 6 to 22 carbon atoms of natural or synthetic origin, more especially from linear, saturated and/or unsaturated fatty acids, including the technical mixtures thereof obtainable by lipolysis from animal and/or vegetable fats and oils, for example from coconut oil, palm kernel oil, palm oil, soya oil, sunflower oil, rapeseed oil, cottonseed oil, fish oil, bovine tallow and lard. Examples of such carboxylic acids are caproic acid, caprylic acid, 2-ethyl hexanoic acid, capric acid, lauric acid, isotridecanoic acid, myristic acid, palmitic acid, palmitoleic acid, stearic acid, isostearic acid, oleic acid, elaidic acid, petroselic acid, linoleic acid, linolenic acid, elaeostearic acid, arachic acid, gadoleic acid, behenic acid and/or erucic acid. Preferred alkyl groups are derived from primary, aliphatic monohydric alcohols containing 1 to 4 carbon atoms which may be saturated and/or unsaturated. Examples of suitable monoalcohols are methanol, ethanol, propanol and butanol, more especially methanol.

OAlk stands for the alkylene oxides which are reacted with the carboxylic acid esters and which comprise ethylene oxide, propylene oxide and/or butylene oxide, preferably ethylene oxide and/or propylene oxide and more particularly ethylene oxide on its own. Alkoxylated carboxylic acid esters corresponding to formula (V), in which OAlk is a CH₂CH₂O group, n is on average a number of 10 to 15 and R⁵ is a methyl group, are particularly suitable. Examples of such compounds are lauric acid methyl ester, coconut oil fatty acid methyl ester and tallow fatty acid methyl ester alkoxylated with on average 5, 7, 9 or 11 mol ethylene oxide. The nonionic surfactants may be used in quantities of 20 to 95, preferably 50 to 80 and more particularly 60 to 70, based on the final concentration.

Hydroxy Mixed Ethers

The hydroxy mixed ethers (HMEs) also suitable as nonionic surfactants are known nonionic surfactants with a nonsymmetrical ether structure and a content of polyalkylene glycols which are obtained, for example, by subjecting olefin epoxides to a ring opening reaction with fatty alcohol polyglycol ethers. Corresponding products and their use in the cleaning of hard surfaces are the subject of, for example, European patent EP 0 693 049 B1 and International patent application WO 94/22800 (Olin) and the documents cited therein. The hydroxy mixed ethers typically correspond to general formula (VI):

R⁶CH(OH)—CHR⁷O(CH₂CHR⁸O)ₙR⁹ (VI)

in which R⁶ is a linear or branched alkyl group containing 2 to 18 and preferably 10 to 16 carbon atoms, R⁷ is hydrogen or a linear or branched alkyl group containing 2 to 18 carbon atoms, R⁸ is hydrogen or methyl, R⁹ is a linear or branched alkyl and/or alkenyl group containing 6 to 22 and preferably 12 to 18 carbon atoms and n is a number of 1 to 50, preferably 2 to 25 and more particularly 5 to 15, with the proviso that the total number of carbon atoms in the substituents R⁶ and R⁷ is at least 4 and preferably 12 to 18. As the formula suggests, the HMEs may be ring opening products both of internal olefins (R⁷≠hydrogen) or terminal olefins (R⁵=hydrogen), the latter being preferred for their more favorable performance properties and their easier production. Similarly, the polar part of the molecule may be a polyethylene glycol or a polypropylene glycol chain. Mixed chains of PE and PP units in statistical or block distribution are also suitable. Typical examples are ring opening products of 1,2-hexene epoxide, 2,3-hexene epoxide, 1,2-octene epoxide, 2,3-octene epoxide, 3,4-octene epoxide, 1,2-decene epoxide, 2,3-decene epoxide, 3,4-decene epoxide, 4,5-decene epoxide, 1,2-dodecene epoxide, 2,3-dodecene epoxide, 3,4-dodecene epoxide, 4,5-dodecene epoxide, 5,6-dodecene epoxide, 1,2-tetradecene epoxide, 2,3-tetradecene epoxide, 3,4-tetradecene epoxide, 4,5-tetradecene epoxide, 5,6-tetradecene epoxide, 6,7-tetradecene epoxide, 1,2-hexadecene epoxide, 2,3-hexadecene epoxide, 3,4-hexadecene epoxide, 4,5-hexadecene epoxide, 5,6-hexadecene epoxide, 6,7-hexadecene epoxide, 7,8-hexadecene epoxide, 1,2-octadecene epoxide, 2,3-octadecene epoxide, 3,4-octadecene epoxide, 4,5-octadecene epoxide, 5,6-octadecene epoxide, 6,7-octadecene epoxide, 7,8-octadecene epoxide and 8,9-octadecene epoxide and mixtures thereof with addition products of on average 1 to 50, preferably 2 to 25 and more particularly 5 to 15 mol ethylene oxide and/or 1 to 10, preferably 2 to 8 and more particularly 3 to 5 mol propylene oxide onto saturated and/or unsaturated primary alcohols containing 6 to 22 and preferably 12 to 18 carbon atoms, such as for example caproic alcohol, caprylic alcohol, 2-ethyl hexyl alcohol, capric alcohol, lauryl alcohol, isotridecyl alcohol, myristyl alcohol, cetyl alcohol, palmitoleyl alcohol, stearyl alcohol, isostearyl alcohol, oleyl alcohol, elaidyl alcohol, petroselinyl alcohol, linolyl alcohol, linolenyl alcohol, elaeostearyl alcohol, arachyl alcohol, gadoleyl alcohol, behenyl alcohol, erucyl alcohol and brassidyl alcohol and technical mixtures thereof. The HMEs are normally present in the shaped bodies in quantities of 0.1 to 20, preferably 0.5 to 8 and more particularly 3 to 5% by weight.

According to the invention, the nonionic surfactant granules used in accordance with the invention may contain a nonionic surfactant or a mixture of two or more nonionic surfactants. If the nonionic surfactant granules contain only nonionic surfactants, the mixture of nonionic surfactants as a whole must have a melting point within the range mentioned. For example, surfactant granules used in accordance with the invention may contain, for example, a nonionic surfactant or a mixture of two or more nonionic surfactants with a melting point outside the above-mentioned range. In such a case, however, the granules must contain at least one other nonionic surfactant which raises the melting point to a value within the above-mentioned range.

However, granules of nonionic surfactants containing a polymeric compacting agent may also be used in accordance with the invention. This may be necessary or advantageous, for example, where the nonionic surfactant or the mixture of two or more nonionic surfactants has a softening point or a melting point which, although lying within the above-mentioned range, is to be increased. Polymeric compacting agents The granules suitable for use in the preparations according to the invention may contain organic polymeric compounds, for example, as compacting agents.

Suitable organic polymeric compounds are cationic, anionic, zwitterionic, amphoteric and/or nonionic organic polymers. In a preferred embodiment of the invention, poly(meth)acrylates, polypeptides, polysaccharides, celluloses, polyvinyl alcohols, polyvinyl pyrrolidone, polycondensates, polyhydroxycarboxylic acids, polyethylene glycol, polyesters, polyurethanes and/or derivatives thereof may be used as organic polymers. Suitable organic cationic polymers are, for example, cationic cellulose derivatives such as, for example, the quaternized hydroxyethyl cellulose obtainable from Amerchol under the name of Polymer JR 400®, cationic starch, copolymers of diallyl ammonium salts and acrylamides, quaternized vinyl pyrrolidone/vinyl imidazole polymers such as, for example, Luviquat® (BASF), condensation products of polyglycols and amines, quaternized collagen polypeptides such as, for example, Lauryldimonium Hydroxypropyl Hydrolyzed Collagen (Lamequat® L, Grünau), quaternized wheat polypeptides, polyethyleneimine, cationic silicone polymers such as, for example, amodimethicone, copolymers of adipic acid and dimethylaminohydroxypropyl diethylenetriamine (Cartaretine®, Sandoz), copolymers of acrylic acid with dimethyl diallyl ammonium chloride (Merquat® 550, Chemviron), polyaminopolyamides as described, for example, in FR 2252840 A and crosslinked water-soluble polymers thereof, cationic chitin derivatives such as, for example, quaternized chitosan, optionally in microcrystalline distribution, condensation products of dihaloalkyls, for example dibromobutane, with bis-dialkylamines, for example bis-dimethylamino-1,3-propane, cationic guar gum such as, for example, Jaguar®CBS, Jaguar®C-17, Jaguar®C-16 of Celanese, quaternized ammonium salt polymers such as, for example, Mirapol® A-15, Mirapol® AD-1, Mirapol® AZ-1 of Miranol.

Suitable organic anionic, zwitterionic, amphoteric and nonionic polymeric compounds are, for example, vinyl acetate/crotonic acid copolymers, vinyl pyrrolidone/vinyl acrylate copolymers, vinyl acetate/butyl maleate/isobornyl acrylate copolymers, methyl vinylether/maleic anhydride copolymers and esters thereof, acrylamidopropyl trimethylammonium chloride/acrylate copolymers, octylacrylamide/methyl methacrylate/tert.-butylaminoethyl methacrylate/2-hydroxypropyl methacrylate copolymers, polyvinyl pyrrolidone, vinyl pyrrolidone/vinyl acetate copolymers, vinyl pyrrolidone/dimethylaminoethyl methacrylate/vinyl caprolactam terpolymers and optionally derivatized cellulose ethers. In a preferred embodiment of the invention, poly(meth)acrylates, polypeptides, polysaccharides, cellulose, polyvinyl alcohols, polyvinyl pyrrolidones, polycondensates, polyhydroxycarboxylic acids and/or derivatives thereof may be used as organic polymeric compounds.

(1) Poly(meth)acrylates

Suitable poly(meth)acrylates are polymeric compounds which can be formed from acrylic acid or methacrylic acid and derivatives thereof known from the prior art. Polyacrylate/methacrylate (for example Sokalan® CP 5: BASF) and polyacrylates (for example Carbopol® and Pemulen types from Goodrich; Synthalene® from Sigma; Keltrol types from Kelco; Sepigel types from Seppic; Salcare types from Allied Colloids) are preferably used.

(2) Proteins

Proteins suitable for the purposes of the invention are polypeptides based on animal protein (for example collagen) or on vegetable protein with a molecular weight of 1,000 to 300,000, preferably 5,000 to 200,000 and more particularly 10,000 to 150,000. One particular embodiment is characterized by the use of water-soluble proteins, for example based on wheat protein. In this case, a molecular weight of 5,000 to 50,000 is particularly preferred. Corresponding proteins based on whey, soya, rice and silk may also be used. Protein hydrolyzates with an average molecular weight of 500 to 30,000 (for example Gluadin® WP, Cognis GmbH) are particularly preferred. In a preferred embodiment of the invention, anionically or cationically modified protein hydrolyzates (for example Gluadin WQ, Cognis GmbH) may also be used. Polypeptides may also be formed in known manner from amino acids and derivatives thereof, i.e. from carboxylic acids containing one or more amino groups in the molecule. According to the invention, the proteins or polypeptides may be prepared by linking the individual amino acids or combinations thereof with one another, in which case suitable amino acids are, for example, glycine, alanine, serine, cysteine, phenylalanine, tyrosine, tryptophane, threonine, methionine, valine, proline, leucine, isoleucine, lysine, arginine, histidine, L-aspartic acid, asparagine, glutamic acid, glutamine and derivatives thereof (for example polyethylene glutamate) which, after derivatization, contain at least one COOH group and at least one amino group. Polyaspartate (for example with a molecular weight of 20,000 (Donlar) or 2,000-3,000 (Bayer) is preferred.

(3) Polysaccharides and/or Derivatives Thereof

Suitable polysaccharides are any known sugars, starch, degraded starch (for example liquid syrup), glycogen, cellulose and derivatives thereof. Preferred polysaccharides are starch, cellulose and derivatives thereof and, more especially, xanthan gum, guar guar (for example guar hydroxypropyl trimethyl ammonium chloride; Cosmedia Guar C 261; Cognis GmbH; guar gum; Cosmedia Guar U, Cognis GmbH), agar agar, alginates and tyloses, carboxymethyl cellulose and hydroxyethyl cellulose, dextrin, cyclodextrin, carboxymethyl dextran and derivatives thereof.

(4) Polyvinyl Alcohols

In the context of the invention, polyvinyl alcohols have the general structure —CH₂CHOH—CH₂CH₂OH and also contain small amounts (ca. 2%) of structural units with the formula CH₂CHOH—CHOH—CH₂OH—. Polyvinyl alcohols cannot be directly obtained by polymerization of polyvinyl alcohol (H₂C═CH—OH) because its concentration in the tautomeric equilibrium (keto-enol tautomerism) with acetaldehyde (H₂C—CHO) is too low. Accordingly, polyvinyl alcohols are prepared above all from polyvinyl acetals by polymer-analog reactions, such as hydrolysis, but more particularly—on an industrial scale—by alkali-catalyzed transesterification with alcohols (preferably methanol) in solution. Polyvinyl alcohols preferably used for the purposes of the invention are commercially available as white-yellowish powders or granules with degrees of polymerization of preferably 500 to 2,500 (molecular weights of ca. 20,000 to 100,000 g/mol). Such products have degrees of hydrolysis of 98 to 99 or 87 to 89 mol-%, i.e. still have a residual content of acetyl groups. Suitable products preferably have a molecular weight of 5,000 to 50,000 and more particularly in the range from 10,000 to 30,000.

(5) Polyvinyl Pyrrolidones

Polyvinyl pyrrolidones [poly(1-vinyl-2-pyrrolidones)] are prepared by radical polymerization of 1-vinyl pyrrolidone by bulk, solution or suspension polymerization using radical formers (peroxides, azo compounds) as initiators and generally in the presence of aliphatic amines which suppress decomposition of the monomer in the acidic medium. The ionic polymerization of the monomer only gives products with low molecular weights. Polyvinyl pyrrolidones with molecular weights of 2,500 to 75,000 g/mol, preferably in the range from 5,000 to 60,000 g/mol and more particularly in the range from 20,000 to 50,000 g/mol are preferably used.

(6) Polyhydroxycarboxylic Acids

Copolymers of vinyl alcohol and (meth)acrylic acids may also be used as polyhydroxycarboxylic acids. A particular embodiment are polyhydroxycarboxylic acids which are prepared by polycondensation of polyhydroxy acids, such as tartaric acid, citric acid, malic acid and mixtures thereof. The organic polymeric support materials may be used in quantities of 0.1 to 50, preferably 1 to 30 and more particularly 5 to 20% by weight, based on the final concentration.

Basically, the granules of nonionic surfactants used in the preparations according to the invention may be produced in any way. In a preferred embodiment of the invention, however, it was found that particularly suitable granules can be obtained by a process known as “dropletization (droplet formation)”.

In this process, the melt of a nonionic surfactant solid at room temperature or a mixture of two or more such surfactants or a mixture of one or more nonionic surfactants and one or more polymeric compacting agents is converted into droplets by means of a vibrating plate provided with holes. The plate vibrates in the direction of its normal plane, particularly regularly shaped droplets with a narrow particle size distribution being obtained according to the viscosity of the melt and the fibration frequency. A particularly suitable machine for carrying out this process is, for example, the Mini-Droppo-Line manufactured by Rieter Automatik GmbH of Grossostheim (Germany). Preferred operating parameters are a vibration frequency of about 100 to 500 Hz, for example about 250 to about 400 Hz, a nozzle diameter of about 200 to 600 μm and more particularly about 250 to 400 μm, a pressure (according to the melt viscosity of the nonionic surfactant) of about 0.4 to about 5 bar and a nozzle temperature of about −10° C. to about +10° C. around the melting point of the nonionic surfactant.

Accordingly, the present invention also relates to a process for the production of granules of solid nonionic surfactants in which a melt at least containing a nonionic surfactant solid at room temperature is discharged through a plate formed with at least one hole and vibrating in the direction of its normal plane in such a way that droplets 100 to 1,200 μm in size are formed.

In another preferred embodiment of the present invention, the droplets are cooled before being gathered in a collector.

Besides granules of a nonionic surfactant solid at room temperature, a detersive preparation according to the invention also contains at least one anionic surfactant.

Anionic Surfactants

Typical examples of anionic surfactants suitable for use in the preparations according to the invention are soaps, alkyl benzenesulfonates, alkane sulfonates, olefin sulfonates, alkyl ether sulfonates, glycerol ether sulfonates, α-methyl ester sulfonates, sulfofatty acids, alkyl and/or alkenyl sulfates, alkylether sulfates, glycerol ether sulfates, hydroxy mixed ether sulfates, fatty alcohol (ether) phosphates, monoglyceride (ether) sulfates, fatty acid amide (ether) sulfates, mono- and dialkyl sulfosuccinates, mono- and dialkyl sulfosuccinamates, sulfotriglycerides, amide soaps, ether carboxylic acids and salts thereof, fatty acid isethionates, fatty acid sarcosinates, fatty acid taurides, N-acyl amino acids such as, for example, acyl lactylates, acyl tartrates, acyl glutamates and acyl aspartates, alkyl oligoglucoside sulfates, protein fatty acid condensates (more particularly vegetable wheat-based products) and alkyl (ether)phosphates. Where the anionic surfactants contain polyglycol ether chains, they may have a conventional homolog distribution although they preferably have a narrow homolog distribution.

Anionic surfactants selected from the group consisting of alkyl and/or alkenyl sulfates, alkyl ether sulfates, alkyl benzenesulfonates, soaps, monoglyceride(ether)sulfates and alkanesulfonates, more particularly fatty alcohol sulfates, fatty alcohol ether sulfates, secondary alkane sulfonates and linear alkyl benzenesulfonates are preferred.

The detergents according to the invention preferably contain 0.1 to 89% by weight, preferably 0.2 to 85% by weight and more particularly 0.5 to 70% by weight anionic surfactants, expressed as active substance and based on the detergent.

Alkyl and/or alkenyl sulfates, which are often also referred to as fatty alcohol sulfates, are understood to be the sulfation products of primary alcohols which correspond to formula (VII):

R¹⁰O—SO₃X (VII)

in which R¹⁰ is a linear or branched, aliphatic alkyl and/or alkenyl group containing 6 to 22 carbon atoms and preferably 12 to 18 carbon atoms and X is an alkali metal and/or alkaline earth metal, ammonium, alkyl ammonium, alkanolammonium or glucammonium.

Typical examples of alkyl sulfates which may be used in accordance with the invention are the sulfation products of caproic alcohol, caprylic alcohol, capric alcohol, 2-ethyl hexyl alcohol, lauryl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol and erucyl alcohol and the technical mixtures thereof obtained by high-pressure hydrogenation of technical methyl ester fractions or aldehydes from Roelen's oxo synthesis. The sulfation products may advantageously be used in the form of their alkali metal salts and particularly their sodium salts. Alkyl sulfates based on C_{16/18} tallow fatty alcohols or vegetable fatty alcohols of comparable C chain distribution in the form of their sodium salts are particularly preferred.

Alkyl Ether Sulfates

Alkyl ether sulfates (“ether sulfates”) are known anionic surfactants which, on an industrial scale, are produced by SO₃ or chlorosulfonic acid (CSA) sulfation of fatty alcohol or oxoalcohol polyglycol ethers and subsequent neutralization. Ether sulfates suitable for use in accordance with the invention correspond to formula (VIII):

R¹¹O—(CH₂CH₂O)ₐSO₃X (VIII)

in which R¹¹ is a linear or branched alkyl and/or alkenyl group containing 6 to 22 carbon atoms, a is a number of 1 to 10 and X is an alkali metal and/or alkaline earth metal, ammonium, alkylammonium, alkanolammonium or glucammonium. Typical examples are the sulfates of addition products of on average 1 to 10 and more particularly 2 to 5 mol ethylene oxide onto caproic alcohol, caprylic alcohol, 2-ethylhexyl alcohol, capric alcohol, lauryl alcohol, isotridecyl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol and brassidyl alcohol and technical mixtures thereof in the form of their sodium and/or magnesium salts. The ether sulfates may have both a conventional homolog distribution and a narrow homolog distribution. It is particularly preferred to use ether sulfates based on adducts of on average 2 to 3 mol ethylene oxide with technical C_{12/14} or C_{12/18} coconut fatty alcohol fractions in the form of their sodium and/or magnesium salts.

Alkyl Benzenesulfonates

Alkyl benzenesulfonates preferably correspond to formula (IX):

R¹²-Ph-SO₃X (IX)

in which R¹² is a branched, but preferably linear alkyl group containing 10 to 18 carbon atoms, Ph is a phenyl group and X is an alkali metal and/or alkaline earth metal, ammonium, alkyl ammonium, alkanolammonium or glucammonium. Codicil benzenesulfonates, tetradecyl benzenesulfonates, hexadecyl benzenesulfonates and technical mixtures thereof in the form of the sodium salts are preferably used.

Soaps

Finally, soaps are understood to be fatty acid salts corresponding to formula (X):

R¹³CO—OX (X)

in which R¹⁴CO is a linear or branched, saturated or unsaturated acyl group containing 6 to 22 and preferably 12 to 18 carbon atoms and X is alkali and/or alkaline earth metal, ammonium, alkylammonium or alkanolammonium. Typical examples are the sodium, potassium, magnesium, ammonium and triethanolammonium salts of caproic acid, caprylic acid, 2-ethylhexanoic acid, capric acid, lauric acid, isotridecanoic acid, myristic acid, palmitic acid, palmitoleic acid, stearic acid, isostearic acid, oleic acid, elaidic acid, petroselic acid, linoleic acid, linolenic acid, elaeostearic acid, arachic acid, gadoleic acid, behenic acid and erucic acid and technical mixtures thereof. Coconut oil fatty acid or palm kernel oil fatty acid in the form of their sodium or potassium salts are preferably used.

Monoglyceride (ether)sulfates

Monoglyceride sulfates and monoglyceride ether sulfates are known anionic surfactants which may be obtained by the relevant methods of preparative organic chemistry. They are normally produced from triglycerides by transesterification to the monoglycerides, optionally after ethoxylation, followed by sulfation and neutralization. The partial glycerides may also be reacted with suitable sulfating agents, preferably gaseous sulfur trioxide or chlorosulfonic acid [cf. EP 0561825 B1, EP 0561999 B1 (Henkel)]. If desired, the neutralized products may be subjected to ultrafiltration to reduce the electrolyte content to a desired level [DE 4204700 A1 (Henkel)]. Overviews of the chemistry of monoglyceride sulfates have been published, for example, by A. K. Biswas et al. in J. Am. Oil. Chem. Soc. 37, 171 (1960) and by F. U. Ahmed in J. Am. Oil. Chem. Soc. 67, 8 (1990). The monoglyceride (ether)sulfates suitable for the purposes of the invention correspond to formula (XI):

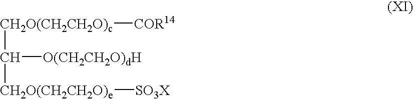

in which R¹⁴CO is a linear or branched acyl group containing 6 to 22 carbon atoms, c, d and e together stand for 0 or numbers of 1 to 30 and preferably 2 to 10 and X is an alkali metal or alkaline earth metal. Typical examples of monoglyceride (ether)sulfates suitable for the purposes of the invention are the reaction products of lauric acid monoglyceride, coconut fatty acid monoglyceride, palmitic acid monoglyceride, stearic acid monoglyceride, oleic acid monoglyceride and tallow fatty acid monoglyceride and ethylene oxide adducts thereof with sulfur trioxide or chlorosulfonic acid in the form of their sodium salts. Monoglyceride sulfates corresponding to formula (XI), in which R¹⁴CO is a linear acyl group containing 8 to 18 carbon atoms, are preferably used.

Alkanesulfonates

Alkane sulfonates may be divided into primary and secondary alkanesulfonates. These are understood to be compounds corresponding to formula (XII):

R¹⁵—CH(SO₃H)—R¹⁶ (XII)

where—in the case of primary alkanesulfonates—R¹⁵ is hydrogen and R¹⁶ is an alkyl group containing no more than 50 carbon atoms. Secondary alkanesulfonates are preferred.

The preparations according to the invention contain the above-mentioned surfactant granules in a quantity of at least about 1% by weight. In a preferred embodiment of the present invention, the preparations according to the invention contain about 2 to about 30 and more particularly about 5 to about 25% by weight of surfactant granules.

The percentage content of anionic surfactants in the preparations according to the invention is about 1 to about 60% by weight and, more particularly, about 5 to about 50 or about 10 to about 40% by weight According to the invention, the preparations according to the invention may be used as detergents. They may be used in the form or powders, granules or shaped bodies, more particularly tablets.

Besides the ingredients already mentioned, the preparations according to the invention may contain other typical ingredients and auxiliaries and additives as described in the following.

Besides the ingredients mentioned, the detergents may contain other typical ingredients such as, for example, builders, bleaching agents, bleach activators, detergency boosters, enzymes, enzyme stabilizers, redeposition inhibitors, optical brighteners, soil repellants, foam inhibitors, inorganic salts and perfumes and dyes.

A particularly suitable solid builder is finely crystalline zeolite containing synthetic and bound water, such as zeolite A in detergent quality. However, zeolite NaX and mixtures of NaA and NaX may also be used. The zeolite may be used in the form of a spray-dried powder or even in the form of an undried stabilized suspension still moist from its production. Where the zeolite is used in the form of a suspension, the suspension may contain small additions of nonionic surfactants as stabilizers, for example 1 to 3% by weight, based on zeolite, of ethoxylated C₁₂ cis-fatty alcohols containing 2 to 5 ethylene oxide groups or ethoxylated isotridecanols. Suitable zeolites have a mean particle size of less than 10 μm (volume distribution, as measured by the Coulter Counter method) and contain preferably 18 to 22% by weight and more preferably 20 to 22% by weight of bound water. Suitable substitutes or partial substitutes for zeolites are crystalline layer-form sodium silicates with the general formula NaMSiₓO₂ₓ₊₁.yH₂O, where M is sodium or hydrogen, x is a number of 1.9 to 4 and y is a number of 0 to 20, preferred values for x being 2, 3 or 4. Crystalline layer silicates such as these are described, for example, in European patent application EP 0 164 514 A1. Preferred crystalline layer silicates corresponding to the above formula are those in which M in the general formula is sodium and x assumes the value 2 or 3. Both β- and δ-sodium disilicates Na₂Si₂O₅.yH₂O are particularly preferred, β-sodium disilicate being obtainable, for example, by the process described in International patent application WO 91/08171. The powder detergents according to the invention preferably contain 10 to 60% by weight zeolite and/or crystalline layer silicates as solid builders. Mixtures of zeolite and crystalline layer silicates in any ratio can be particularly advantageous. In a particularly preferred embodiment, the detergents contain 20 to 50% by weight zeolite and/or crystalline layer silicates. Particularly preferred detergents contain up to 40% by weight zeolite and more particularly up to 35% by weight zeolite, based on water-free active substance. Other suitable ingredients of the detergents are water-soluble amorphous silicates which are preferably used in combination with zeolite and/or crystalline layer silicates.

Preparations containing, above all, sodium silicate with a molar Na₂O:SiO₂ ratio (modulus) of 1:1 to 1:4.5 and preferably in the range from 1:2 to 1:3.5 are particularly preferred. The amorphous sodium silicate content of the preparations is preferably up to 15% by weight and more particularly between 2 and 8% by weight. Phosphates, such as tripolyphosphates, pyrophosphates and orthophosphates may also be present in the preparations in small quantities. The phosphate content of the preparations is up to 15% by weight and more particularly from 0 to 10% by weight. The preparations may additionally contain layer silicates of natural and synthetic origin. Such layer silicates are known, for example, from patent applications DE 23 34 899 B, EP 0 026 529 A and DE 35 26 405 A. Their suitability is not confined to a particular composition or structural formula. However, smectites, especially bentonites, are preferred. Suitable layer silicates which belong to the group of water-swellable smectites are, for example, montmorillonite, hectorite or saponite. In addition, small quantities of iron may be incorporated in the crystal lattice of the layer silicates. By virtue of their ion-exchanging properties, the layer silicates may additionally contain hydrogen, alkali metal, alkaline earth metal ions, more particularly Na⁺ and Ca⁺⁺. The water of hydration content is generally between 8 and 20% by weight, depending on the degree of swelling and the processing technique. Useful layer silicates are known, for example, from U.S. Pat. Nos. 3,966,629, 4,062,647, EP 0 026 529 A and EP 0 028 432 A. Layer silicates substantially free from calcium ions and strongly coloring iron ions by an alkali treatment are preferably used.

Useful organic builders are, for example, the polycarboxylic acids usable in the form of their sodium salts, such as citric acid, adipic acid, succinic acid, glutaric acid, tartaric acid, sugar acids, aminocarboxylic acids, nitrilotriacetic acid (NTA), providing its use is not ecologically unsafe, and mixtures thereof. Preferred salts are the salts of the polycarboxylic acids, such as citric acid, adipic acid, succinic acid, glutaric acid, tartaric acid, sugar acids and mixtures thereof. Suitable polymeric polycarboxylates are, for example, the sodium salts of polyacrylic acid or polymethacrylic acid, for example those with a relative molecular weight of 800 to 150,000 (based on acid). Suitable copolymeric polycarboxylates are, in particular, those of acrylic acid with methacrylic acid and of acrylic acid or methacrylic acid with maleic acid. Acrylic acid/maleic acid copolymers containing 50 to 90% by weight of acrylic acid and 50 to 10% by weight of maleic acid have proved to be particularly suitable. Their relative molecular weight, based on free acids, is generally in the range from 5,000 to 200,000, preferably in the range from 10,000 to 120,000 and more preferably in the range from 50,000 to 100,000. The use of polymeric polycarboxylates is not absolutely essential. However, if polymeric polycarboxylates are used, preparations containing biodegradable polymers, for example terpolymers which contain acrylic acid and maleic acid or salts thereof and vinyl alcohol or vinyl alcohol derivatives as monomers or acrylic acid and 2-alkylallyl sulfonic acid or salts and sugar derivatives as monomers, are preferred. Terpolymers obtained in accordance with the teaching of German patent applications DE 42 21 381 A and DE 43 00 772 A are particularly suitable.

Other suitable builders are polyacetals which may be obtained by reaction of dialdehydes with polyol carboxylic acids containing 5 to 7 carbon atoms and at least three hydroxyl groups, for example as described in European patent application EP 0 280 223 A. Preferred polyacetals are obtained from dialdehydes, such as glyoxal, glutaraldehyde, terephthalaldehyde and mixtures thereof and from polyol carboxylic acids, such as gluconic acid and/or glucoheptonic acid.

Among the compounds yielding hydrogen peroxide in water which serve as bleaching agents, sodium perborate tetrahydrate and sodium perborate monohydrate are particularly important.

Other bleaching agents are, for example, peroxypercarbonate, citrate perhydrates and salts of peracids, such as perbenzoates, peroxyphthalates or diperdodecanedioic acid. They are normally used in quantities of 8 to 25% by weight. It is preferred to use sodium perborate monohydrate in quantities of 10 to 2O % by weight and more particularly in quantities of 10 to 15% by weight. Through its ability to bind free water to form the tetrahydrate, it contributes towards increasing the stability of the preparation.

In order to obtain an improved bleaching effect where washing is carried out at temperatures of 60° C. or lower, bleach activators may be incorporated in the preparations. Examples of bleach activators are N-acyl or O-acyl compounds which form organic peracids with hydrogen peroxide, preferably N,N′-tetraacylated diamines, carboxylic anhydrides and esters of polyols, such as glucose pentaacetate. The bleach activator content of the bleach-containing preparations is in the usual range, preferably between 1 and 10% by weight and more particularly between 3 and 8% by weight. Particularly preferred bleach activators are N,N,N′,N′-tetraacetyl ethylenediamine and 1,5-diacetyl-2,4-dioxohexahydro-1,3,5-triazine.

Suitable enzymes are enzymes from the class of proteases, lipases, amylases, cellulases and mixtures thereof. Enzymes obtained from bacterial strains or fungi, such as Bacillus subtilis, Bacillus licheniformis and Streptomyces griseus are particularly suitable. Proteases of the subtilisin type are preferably used, proteases obtained from Bacillus lentus being particularly preferred. The enzymes may be adsorbed to supports and/or encapsulated in membrane materials to protect them against premature decomposition. In addition to the monohydric and polyhydric alcohols, the preparations may contain other enzyme stabilizers. For example, 0.5 to 1% by weight of sodium formate may be used. Proteases stabilized with soluble calcium salts and having a calcium content of preferably about 1.2% by weight, based on the enzyme, may also be used. However, it is of particular advantage to use boron compounds, for example boric acid, boron oxide, borax and other alkali metal borates, such as the salts of orthoboric acid, metaboric acid and pyroboric acid.

The function of redeposition inhibitors is to keep the soil detached from the fibers suspended in the wash liquor and thus to prevent the soil from being re-absorbed by the washing. Suitable redeposition inhibitors are water-soluble, generally organic colloids, for example the water-soluble salts of polymeric carboxylic acids, glue, gelatine, salts of ether carboxylic acids or ether sulfonic acids of starch or cellulose or salts of acidic sulfuric acid esters of cellulose or starch. Water-soluble polyamides containing acidic groups are also suitable for this purpose. Soluble starch preparations and other starch products than those mentioned above, for example degraded starch, aldehyde starches, etc., may also be used. Polyvinyl pyrrolidone is also suitable. However, cellulose ethers, such as carboxymethyl cellulose, methyl cellulose, hydroxyalkyl cellulose, and mixed ethers, such as methyl hydroxyethyl cellulose, methyl hydroxypropyl cellulose, methyl carboxymethyl cellulose and mixtures thereof, and polyvinyl pyrrolidone are also preferably used, for example in quantities of 0.1 to 5% by weight, based on the detergent. The preparations may contain derivatives of diaminostilbene disulfonic acid or alkali metal salts thereof as optical brighteners. Suitable optical brighteners are, for example, salts of 4,4′-bis-(2-anilino-4-morpholino-1,3,5-triazinyl-6-amino)-stilbene-2,2′-disulfonic acid or compounds of similar structure which contain a diethanolamino group, a methylamino group an anilino group or a 2-methoxyethylamino group instead of the morpholino group. Brighteners of the substituted diphenyl styryl type, for example alkali metal salts of 4,4′-bis-(2-sulfostyryl)-diphenyl, 4,4′-bis-(4-chloro-3-sulfostyryl)-diphenyl or 4-(4-chlorostyryl)-4′-(2-sulfostyryl)-diphenyl, may also be present. Mixtures of the brighteners mentioned may also be used. Uniformly white granules are obtained if, in addition to the usual brighteners in the usual quantities, for example between 0.1 and 0.5% by weight and preferably between 0.1 and 0.3% by weight, the preparations also contain small quantities, for example 10⁻⁶ to 10⁻³% by weight and preferably around 10⁻⁵% by weight, of a blue dye. A particularly preferred dye is Tinolux® (a product of Ciba-Geigy).

Suitable soil repellent-polymers (soil repellants) are substances which preferably contain ethylene terephthalate and/or polyethylene glycol terephthalate groups, the molar ratio of ethylene terephthalate to polyethylene glycol terephthalate being in the range from 50:50 to 90:10. The molecular weight of the linking polyethylene glycol units is more particularly in the range from 750 to 5,000, i.e. the degree of ethoxylation of the polymers containing polyethylene glycol groups may be about 15 to 100. The polymers are distinguished by an average molecular weight of about 5,000 to 200,000 and may have a block structure, but preferably have a random structure. Preferred polymers are those with molar ethylene terephthalate:polyethylene glycol terephthalate ratios of about 65:35 to about 90:10 and preferably in the range from about 70:30 to 80:20. Other preferred polymers are those which contain linking polyethylene glycol units with a molecular weight of 750 to 5,000 and preferably in the range from 1,000 to about 3,000 and which have a molecular weight of the polymer of about 10,000 to about 50,000. Examples of commercially available polymers are the products Milease® T (ICI) or Repelotex® SRP 3 (Rhône-Poulenc).

Defoamers

Wax-like compounds may be used as defoamers. “Wax-like” compounds are understood to be compounds which have a melting point at atmospheric pressure above 25° C. (room temperature), preferably above 50° C. and more preferably above 70° C. The wax-like defoamers are substantially insoluble in water, i.e. their solubility in 100 g of water at 20° C. is less than 0.1% by weight. In principle, any wax-like defoamers known from the prior art may additionally be present. Suitable wax-like compounds are, for example, bisamides, fatty alcohols, fatty acids, carboxylic acid esters of monohydric and polyhydric alcohols and paraffin waxes or mixtures thereof. Alternatively, the silicone compounds known for this purpose may of course also be used.

Suitable paraffin waxes are generally a complex mixture with no clearly defined melting point. For characterization, its melting range is normally determined by differential thermoanalysis (DTA), as described in “The Analyst” 87 (1962), 420, and/or its solidification point is determined. The solidification point is understood to be the temperature at which the paraffin changes from the liquid state into the solid state by slow cooling. Paraffins which are entirely liquid at room temperature, i.e. paraffins with a solidification point below 25° C., are not suitable for use in accordance with the invention. Soft waxes which have a melting point of 35 to 50° C. preferably include the group of petrolates and hydrogenation products thereof. They are composed of microcrystalline paraffins and up to 70% by weight of oil, have an ointment-like to plastic, firm consistency and represent bitumen-free residues from the processing of petroleum. Distillation residues (petrolatum stock) of certain paraffin-based and mixed-base crude oils further processed to Vaseline are particularly preferred. Bitumen-free oil-like to solid hydrocarbons separated from distillation residues of paraffin-based or mixed-base crude oil and cylinder oil distillates are also preferred. They are of semisolid, smooth, tacky to plastic and firm consistency and have melting points of 50 to 70° C. These petrolates are the most important starting materials for the production of microwaxes. The solid hydrocarbons with melting points of 63 to 79° C. separated from high-viscosity, paraffin-containing lubricating oil distillates during deparaffinization are also suitable. These petrolates are mixtures of microcrystalline waxes and high-melting n-paraffins. It is possible, for example, to use the paraffin wax mixtures known from EP 0309931 A1 of, for example, 26% by weight to 49% by weight of microcrystalline paraffin wax with a solidification point of 62° C. to 90° C., 20% by weight to 49% by weight of hard paraffin with a solidification point of 42° C. to 56° C. and 2% by weight to 25% by weight of soft paraffin with a solidification point of 35° C. to 40° C. Paraffins or paraffin mixtures which solidify at temperatures of 30° C. to 90° C. are preferably used. It is important in this connection to bear in mind that even paraffin wax mixtures which appear solid at room temperature may contain different amounts of liquid paraffin. In the paraffin waxes suitable for use in accordance with the invention, this liquid component is as small as possible and is preferably absent altogether. Thus, particularly preferred paraffin wax mixtures have a liquid component at 30° C. of less than 10% by weight and, more particularly, from 2% by weight to 5% by weight, a liquid component at 40° C. of less than 30% by weight, preferably from 5% by weight to 25% by weight and more preferably from 5% by weight to 15% by weight, a liquid component at 60° C. of 30% by weight to 60% by weight and preferably 40% by weight to 55% by weight, a liquid component at 80° C. of 80% by weight to 100% by weight and a liquid component at 90° C. of 100% by weight. In particularly preferred paraffin wax mixtures, the temperature at which a liquid component of 100% by weight of the paraffin wax is reached is still below 85° C. and, more particularly, between 75° C. and 82° C. The paraffin waxes may be petrolatum, microcrystalline waxes or hydrogenated or partly hydrogenated paraffin waxes.

Bisamides suitable as defoamers are those derived from saturated fatty acids containing 12 to 22 and preferably 14 to 18 carbon atoms and from alkylenediamines containing 2 to 7 carbon atoms. Suitable fatty acids are lauric acid, myristic acid, stearic acid, arachic acid and behenic acid and the mixtures thereof obtainable from natural fats or hydrogenated oils, such as tallow or hydrogenated palm oil. Suitable diamines are, for example, ethylenediamine, 1,3-propylenediamine, tetramethylenediamine, pentamethylenediamine, hexamethylenediamine, p-phenylenediamine and toluylenediamine. Preferred diamines are ethylenediamine and hexamethylenediamine. Particularly preferred bisamides are bis-myristoyl ethylenediamine, bis-palmitoyl ethylenediamine, bis-stearoyl ethylenediamine and mixtures thereof and the corresponding derivatives of hexamethylenediamine.

Suitable carboxylic acid esters as defoamers are derived from carboxylic acids containing 12 to 28 carbon atoms. The esters in question are, in particular, esters of behenic acid, stearic acid, hydroxystearic acid, oleic acid, palmitic acid, myristic acid and/or lauric acid. The alcohol moiety of the carboxylic acid ester contains a monohydric or polyhydric alcohol containing 1 to 28 carbon atoms in the hydrocarbon chain. Examples of suitable alcohols are behenyl alcohol, arachidyl alcohol, coconut alcohol, 12-hydroxystearyl alcohol, oleyl alcohol and lauryl alcohol and ethylene glycol, glycerol, polyvinyl alcohol, sucrose, erythritol, pentaerythritol, sorbitan and/or sorbitol. Preferred esters are esters of ethylene glycol, glycerol and sorbitan, the acid moiety of the ester being selected in particular from behenic acid, stearic acid, oleic acid, palmitic acid or myristic acid. Suitable esters of polyhydric alcohols are, for example, xylitol monopalmitate, pentaerythritol monostearate, glycerol monostearate, ethylene glycol monostearate and sorbitan monostearate, sorbitan palmitate, sorbitan monolaurate, sorbitan dilaurate, sorbitan distearate, sorbitan dibehenate, sorbitan dioleate and mixed tallow alkyl sorbitan monoesters and diesters. Suitable glycerol esters are the mono-, di- or triesters of glycerol and the carboxylic acids mentioned, the monoesters and diesters being preferred. Glycerol monostearate, glycerol monooleate, glycerol monopalmitate, glycerol monobehenate and glycerol distearate are examples. Examples of suitable natural esters as defoamers are beeswax and carnauba wax, carnauba wax being a mixture of carnauba acid alkyl esters, often in combination with small amounts of free carnauba acid, other long-chain acids, high molecular weight alcohols and hydrocarbons.

Suitable carboxylic acids as another defoamer compound are, in particular, behenic acid, stearic acid, oleic acid, palmitic acid, myristic acid and lauric acid and the mixtures thereof obtainable from natural fats or optionally hydrogenated oils, such as tallow or hydrogenated palm oil. Saturated fatty acids containing 12 to 22 and, more particularly, 18 to 22 carbon atoms are preferred.

Suitable fatty alcohols as another defoamer compound are the hydrogenated products of the described fatty acids.

Dialkyl ethers may also be present as defoamers. The ethers may have an asymmetrical or symmetrical structure, i.e. they may contain two identical or different alkyl chains, preferably containing 8 to 18 carbon atoms. Typical examples are di-n-octyl ether, di-i-octyl ether and di-n-stearyl ether, dialkyl ethers with a melting point above 25° C. and more particularly above 40° C. being particularly suitable.

Other suitable defoamer compounds are fatty ketones which may be obtained by the relevant methods of preparative organic chemistry. They are produced, for example, from carboxylic acid magnesium salts which are pyrolyzed at temperatures above 300° C. with elimination of carbon dioxide and water, for example in accordance with DE 2553900 OS. Suitable fatty ketones are produced by pyrolysis of the magnesium salts of lauric acid, myristic acid, palmitic aid, palmitoleic acid, stearic acid, oleic acid, elaidic acid, petroselic acid, arachic acid, gadoleic acid, behenic acid or erucic acid.

Other suitable defoamers are fatty acid polyethylene glycol esters which are preferably obtained by the homogeneously base-catalyzed addition of ethylene oxide onto fatty acids. The addition of ethylene oxide onto the fatty acids takes place in particular in the presence of alkanolamines as catalysts. The use of alkanolamines, especially triethanolamine, leads to extremely selective ethoxylation of the fatty acids, particularly where it is desired to produce compounds with a low degree of ethoxylation. Within the group of fatty acid polyethylene glycol esters, those with a melting point above 25° C. and more particularly above 40° C. are preferred.

Within the group of wax-like defoamers, the described paraffin waxes—in a particularly preferred embodiment—are used either on their own as wax-like defoamers or in admixture with one of the other wax-like defoamers, the percentage content of the paraffin waxes in the mixture preferably exceeding 50% by weight, based on the wax-like defoamer mixture. If necessary, the paraffin waxes may be applied to supports. Suitable support materials in the context of the present invention are any known inorganic and/or organic support materials. Examples of typical inorganic support materials are alkali metal carbonates, alumosilicates, water-soluble layered silicates, alkali metal silicates, alkali metal sulfates, for example sodium sulfate, and alkali metal phosphates. The alkali metal silicates are preferably a compound with a molar ratio of alkali metal oxide to SiO₂ of 1:1.5 to 1:3.5. The use of silicates such as these results in particularly good particle properties, more particularly high abrasion resistance and at the same time a high dissolving rate in water. Alumosilicates as a support material include, in particular, the zeolites, for example zeolite NaA and NaX.

The compounds described as water-soluble layered silicates include, for example, amorphous or crystalline waterglass. Silicates commercially available as Aerosil® or Sipernat® may also be used.

Suitable organic carrier materials are, for example, film-forming polymers, for example polyvinyl alcohols, polyvinyl pyrrolidones, poly(meth)-acrylates, polycarboxylates, cellulose derivatives and starch. Suitable cellulose ethers are, in particular, alkali metal carboxymethyl cellulose, methyl cellulose, ethyl cellulose, hydroxyethyl cellulose and so-called cellulose mixed ethers, for example methyl hydroxyethyl cellulose and methyl hydroxypropyl cellulose, and mixtures thereof. Particularly suitable mixtures are mixtures of sodium carboxymethyl cellulose and methyl cellulose, the carboxymethyl cellulose normally having a degree of substitution of 0.5 to 0.8 carboxymethyl groups per anhydroglucose unit while the methyl cellulose has a degree of substitution of 1.2 to 2 methyl groups per anhydroglucose unit. The mixtures preferably contain alkali metal carboxymethyl cellulose and nonionic cellulose ether in ratios by weight of 80:20 to 40:60 and, more particularly, 75:25 to 50:50. Another suitable support is native starch which is made up of amylose and amylopectin. Native starch is starch obtainable as an extract from natural sources, for example from rice, potatoes, corn and wheat. Native starch is a standard commercial product and is therefore readily available. Suitable support materials are individual compounds or several of the compounds mentioned above selected in particular from the group of alkali metal carbonates, alkali metal sulfates, alkali metal phosphates, zeolites, water-soluble layered silicates, alkali metal silicates, polycarboxylates, cellulose ethers, polyacrylate/polymethacrylate and starch. Mixtures of alkali metal carbonates, more particularly sodium carbonate, alkali metal silicates, more particularly sodium silicate, alkali metal sulfates, more particularly sodium sulfate, and zeolites are particularly suitable.

Suitable silicones in the context of the present invention are typical organopolysiloxanes containing fine-particle silica which, in turn, may even be silanized. Corresponding organopolysiloxanes are described, for example, in European patent application EP 0496510 A1. Polydiorganosiloxanes and, in particular, polydimethylsiloxanes known from the prior art are particularly preferred. Suitable polydiorganosiloxanes have a substantially linear chain and a degree of oligomerization of 40 to 1,500. Examples of suitable substituents are methyl, ethyl, propyl, isobutyl, tert.butyl and phenyl. Amino-, fatty-acid-, alcohol-, polyether-, epoxy-, fluorine-, glycoside- and/or alkyl-modified silicone compounds which may be both liquid and resin-like at room temperature are also suitable, as are simethicones, i.e. mixtures of dimethicones with an average chain length of 200 to 300 dimethyl siloxane units and hydrogenated silicates. Normally, the silicones in general and the polydiorganosiloxanes in particular contain fine-particle silica which may even be silanized. Silica-containing dimethyl polysiloxanes are particularly suitable for the purposes of the invention. The polydiorganosiloxanes advantageously have a Brookfield viscosity at 25° C. (spindle 1, 10 r.p.m.) of 5,000 mPas to 30,000 mPas and, more particularly, 15,000 mPas to 25,000 mPas. The silicones are preferably used in the form of aqueous emulsions.

The silicone is generally added with stirring to water. If desired, thickeners known from the prior art may be added to the aqueous silicone emulsions to increase their viscosity. These known thickeners may be inorganic and/or organic materials, particularly preferred thickeners being nonionic cellulose ethers, such as methyl cellulose, ethyl cellulose and mixed ethers, such as methyl hydroxyethyl cellulose, methyl hydroxypropyl cellulose, methyl hydroxybutyl cellulose and anionic carboxycellulose types, such as carboxymethyl cellulose sodium salt (CMC).

The preparations according to the invention may contain cationic surfactants in small quantities, for example up to about 2% by weight. Typical examples of cationic surfactants are, in particular, tetraalkylammonium compounds such as, for example, dimethyl distearyl ammonium chloride or Hydroxyethyl Hydroxycetyl Dimmonium Chloride (Dehyquart E) and esterquats. Esterquats are, for example, quaternized fatty acid triethanolamine ester salts corresponding to formula (XIII):

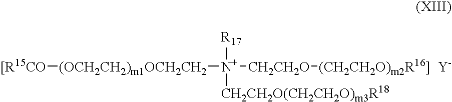

in which R¹⁵CO is an acyl group containing 6 to 22 carbon atoms, R¹⁶ and R¹⁷ independently of one another represent hydrogen or have the same meaning as R¹⁵CO, R¹⁶ is an alkyl group containing 1 to 4 carbon atoms or a (CH₂CH₂O)ₘ₄H group, m1, m2 and m3 together stand for 0 or numbers of 1 to 12, m4 is a number of 1 to 12 and Y is halide, alkyl sulfate or alkyl phosphate. Typical examples of esterquats which may be used in accordance with the invention are products based on caproic acid, caprylic acid, capric acid, lauric acid, myristic acid, palmitic acid, isostearic acid, stearic acid, oleic acid, elaidic acid, arachic acid, behenic acid and erucic acid and the technical mixtures thereof obtained for example in the pressure hydrolysis of natural fats and oils. Technical C_{12/18} coconut fatty acids and, in particular, partly hydrogenated C_{16/18} tallow or palm oil fatty acids and high-elaidic C_{16/18} fatty acid cuts are preferably used. To produce the quaternized esters, the fatty acids and the triethanolamine may be used in a molar ratio of 1.1:1 to 3:1. With the performance properties of the esterquats in mind, a ratio of 1.2:1 to 2.2:1 and preferably 1.5:1 to 1.9:1 has proved to be particularly advantageous. The preferred esterquats are technical mixtures of mono-, di- and triesters with an average degree of esterification of 1.5 to 1.9 and are derived from technical C_{16/18} tallow or palm oil fatty acid (iodine value 0 to 40). In performance terms, quaternized fatty acid triethanolamine ester salts corresponding to formula (XIII), in which R¹⁵CO is an acyl group containing 16 to 18 carbon atoms, R¹⁶ has the same meaning as R¹⁵CO, R¹⁷ is hydrogen, R¹⁸ is a methyl group, m1, m2 and m3 stand for 0 and Y stands for methyl sulfate, have proved to be particularly advantageous.

Other suitable esterquats besides the quaternized fatty acid triethanolamine ester salts are quaternized ester salts of fatty acids with diethanolalkyamines corresponding to formula (XIV):

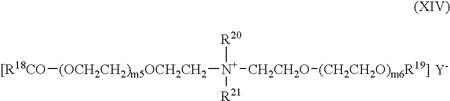

in which R¹⁸CO is an acyl group containing 6 to 22 carbon atoms, R¹⁹ is hydrogen or has the same meaning as R¹⁸ CO, R²⁰ and R²¹ independently of one another are alkyl groups containing 1 to 4 carbon atoms, m5 and m6 together stand for 0 or numbers of 1 to 12 and Y stands for halide, alkyl sulfate or alkyl phosphate. Finally, another group of suitable esterquats are the quaternized ester salts of fatty acids with 1,2-dihydroxypropyl dialkylamines corresponding to formula (XV):

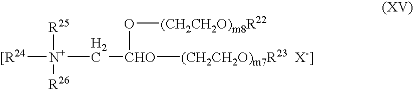

in which R²²CO is an acyl group containing 6 to 22 carbon atoms, R²³ is hydrogen or has the same meaning as R²²CO, R²⁴, R²⁵ and R²⁶ independently of one another are alkyl groups containing 1 to 4 carbon atoms, m7 and m8 together stand for 0 or numbers of 1 to 12 and X stands for halide, alkyl sulfate or alkyl phosphate.

Finally, other suitable esterquats are substances in which the ester bond is replaced by an amide bond and which—preferably based on diethylenetriamine—correspond to formula (XVI):

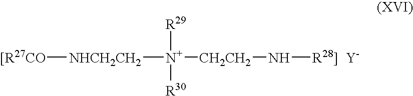

in which R²⁷CO is an acyl group containing 6 to 22 carbon atoms, R²⁸ is hydrogen or has the same meaning as R²⁷CO, R²⁹ and R³⁰ independently of one another are alkyl groups containing 1 to 4 carbon atoms and Y is halide, alkyl sulfate or alkyl phosphate. Amide esterquats such as these are commercially obtainable, for example, under the name of Incroquat® (Croda).

Examples of suitable amphoteric or zwitterionic surfactants are alkyl betaines, alkyl amidobetaines, aminopropionates, aminoglycinates, imidazolinium betaines and sulfobetaines. Examples of suitable alkyl betaines are the carboxyalkylation products of secondary and, in particular, tertiary amines corresponding to formula (XVII):

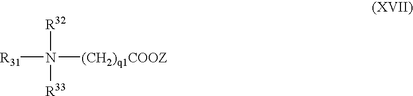

in which R³¹ represents alkyl and/or alkenyl groups containing 6 to 22 carbon atoms, R³² represents hydrogen or alkyl groups containing 1 to 4 carbon atoms, R³³ represents alkyl groups containing 1 to 4 carbon atoms, q1 is a number of 1 to 6 and Z is an alkali metal and/or alkaline earth metal or ammonium. Typical examples are the carboxymethylation products of hexylmethyl amine, hexyldimethyl amine, octyldimethyl amine, decyldimethyl amine, dodecylmethyl amine, dodecyldimethyl amine, dodecylethylmethyl amine, C_{12/14} cocoalkyldimethyl amine, myristyldimethyl amine, cetyldimethyl amine, stearyldimethyl amine, stearylethylmethyl amine, oleyldimethyl amine, C_{16/18} tallow alkyldimethyl amine and technical mixtures thereof.

Also suitable are carboxyalkylation products of amidoamines corresponding to formula (XVIII):

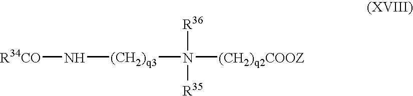

in which R³⁴CO is an aliphatic acyl group containing 6 to 22 carbon atoms and 0 or 1 to 3 double bonds, R³⁵ is hydrogen or represents alkyl groups containing 1 to 4 carbon atoms, R³⁶ represents alkyl groups containing 1 to 4 carbon atoms, q2 is a number of 1 to 6, q3 is a number of 1 to 3 and Z is again an alkali metal and/or alkaline earth metal or ammonium. Typical examples are reaction products of fatty acids containing 6 to 22 carbon atoms, namely caproic acid, caprylic acid, capric acid, lauric acid, myristic acid, palmitic acid, palmitoleic acid, stearic acid, isostearic acid, oleic acid, elaidic acid, petroselic acid, linoleic acid, linolenic acid, elaeostearic acid, arachic acid, gadoleic acid, behenic acid and erucic acid and technical mixtures thereof, with N,N-dimethylaminoethyl amine, N,N-dimethylaminopropyl amine, N,N-diethylaminoethyl amine and N,N-diethylaminopropyl amine which are condensed with sodium chloroacetate. A condensation product of C_{8/18}-cocofatty acid-N,N-dimethylaminopropyl amide with sodium chloroacetate is preferably used.

Imidazolinium betaines may also be used. These compounds are also known compounds which may be obtained, for example, by cyclizing condensation of 1 or 2 moles of fatty acid with polyfunctional amines such as, for example, aminoethyl ethanolamine, (AEEA) or diethylenetriamine. The corresponding carboxyalkylation products are mixtures of different open-chain betaines. Typical examples are condensation products of the fatty acids mentioned above with AEEA, preferably imidazolines based on lauric acid or—again—C_{12/14} coconut fatty acid which are subsequently betainized with sodium chloroacetate.

The total quantity of auxiliaries and additives may be from 1 to 70% by weight and is preferably from 5 to 60% by weight, based on the preparation as a whole.

Suitable perfume oils or perfumes include individual perfume compounds, for example synthetic products of the ester, ether, aldehyde, ketone, alcohol and hydrocarbon type. Perfume compounds of the ester type are, for example, benzyl acetate, phenoxyethyl isobutyrate, p-tert.butyl cyclohexyl acetate, linalyl acetate, dimethyl benzyl carbinyl acetate, phenyl ethyl acetate, linalyl benzoate, benzyl formate, ethyl methyl phenyl glycinate, allyl cyclohexyl propionate, styrallyl propionate and benzyl salicylate. The ethers include, for example, benzyl ethyl ether; the aldehydes include, for example, the linear alkanals containing 8 to 18 carbon atoms, citral, citronellal, citronellyloxyacetaldehyde, cyclamen aldehyde, hydroxycitronellal, lilial and bourgeonal; the ketones include, for example, the ionones, α-isomethyl ionone and methyl cedryl ketone; the alcohols include anethol, citronellol, eugenol, geraniol, linalool, phenyl ethyl alcohol and terpineol and the hydrocarbons include, above all, the terpenes, such as limonene and pinene. However, mixtures of various perfumes which together produce an attractive perfume note are preferably used. Perfume oils such as these may also contain natural perfume mixtures obtainable from vegetable sources, for example pine, citrus, jasmine, patchouli, rose or ylang-ylang oil. Also suitable are clary oil, camomile oil, clove oil, melissa oil, mint oil, cinnamon leaf oil, lime blossom oil, juniper berry oil, vetivert oil, olibanum oil, galbanum oil and ladanum oil and orange blossom oil, neroli oil, orange peel oil and sandalwood oil.

The perfumes may be directly incorporated in the preparations according to the invention, although it can also be of advantage to apply the perfumes to supports which strengthen the adherence of the perfume to the washing and which provide the textiles with a long-lasting fragrance through a slower release of the perfume. Suitable support materials are, for example, cyclodextrins, the cyclodextrin/perfume complexes optionally being coated with other auxiliaries.

Fillers

If desired, the final preparations may also contain inorganic salts, for example sodium sulfate, as fillers, preferably in quantities of 0 to 10% by weight and more particularly in quantities of 1 to 5% by weight, based on the preparation.

In a preferred embodiment of the invention, the preparations according to the invention are detergent tablets.

Production of the Detergent Tablets

The production of the detergent tablets using the nonionic surfactant granules and the described auxiliaries and additives, for example builders, is generally carried out in known manner, for example by tabletting. The tablets obtained may either be directly used as detergents or may be aftertreated beforehand by conventional methods. Conventional aftertreatments include, for example, powdering with fine-particle detergent ingredients which, in general, produces a further increase in bulk density. However, another preferred aftertreatment is the procedure according to German patent applications DE 195 24 287 A1 and DE 195 47 457 A1, according to which dust-like or at least fine-particle ingredients (so-called fine components) are bonded to the particulate end products produced in accordance with the invention which serve as core. This results in the formation of detergents which contain these so-called fine components as an outer shell.

Advantageously, this is again done by melt agglomeration. On the subject of the melt agglomeration of fine components, reference is specifically made to the disclosure of German patent applications DE-A-195 24 287 and DE-A-195 47 457. In the preferred embodiment of the invention, the solid detergents are present in tablet form, the tablets preferably having rounded corners and edges, above all in the interests of safer storage and transportation. The base of the tablets may be, for example, circular or rectangular in shape. Multilayer tablets, particularly tablets containing two or three layers which may even have different colors, are particularly preferred. The tablets may also have compressed and non-compressed parts.

The invention is illustrated by the following Examples.

Production of Nonionic Surfactant Granules:

A mixture of 90% Dehydol® LS30+10% PEG 12000 was converted into droplets in a Rieter Mini Droppo Line with the following operating parameters: nozzle diameter 300 μm, pressure 2.8 bar, frequency 300 Hz, incoming air temperature 4° C., melt temperature 51° C., nozzle temperature 67° C. Almost completely spherical microspheres with a mean particle diameter of about 700 μm were obtained.

Production of a Detergent Tablet:

The nonionic surfactant granules obtained as described above were mixed with soda, anionic surfactant and other typical ingredients.

For comparison, an identical formulation was produced in which the nonionic surfactant granules according to the invention were replaced by an identical quantity of a liquid nonionic surfactant.

Whereas a punch compressive force of the punch tabletting machine of 5.3 kN was required to produce tablets from a mixture according to the invention, the comparison mixture required a punch compressive force of 79 kN.

In another comparison, a formulation identical with the above-mentioned formulations was tabletted without nonionic surfactant (the missing quantity of nonionic surfactant was replaced by sodium sulfate), the punch compressive force required amounting to 44 kN.

The fracture hardness of the tablets according to the invention was greater than the fracture hardness of the comparison examples. Although the comparison formulation without nonionic surfactant had the fastest disintegration time, the tablets according to the invention had a shorter disintegration time than the comparison tablets containing liquid nonionic surfactant.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A detergent composition comprising a nonionic surfactant, wherein the nonionic surfactant is solid at room temperature and is in granular form, and at least one anionic surfactant.

2. The detergent composition according to claim 1, wherein the nonionic surfactant is present in an amount of at least 2% by weight based on the composition.

3. The detergent composition according to claim 1, wherein the anionic surfactant is present in an amount of at least 2% by weight based on the composition.

4. The detergent composition according to claim 2, wherein the anionic surfactant is present in an amount of at least 2% by weight based on the composition.

5. The detergent composition according to claim 1, wherein the nonionic surfactant is present as granules having a mean particle size of from 100 to 1200 μm.

6. The detergent composition according to claim 1, wherein the nonionic surfactant comprises at least one alkoxylated fatty alcohol.

7. The detergent composition according to claim 6, wherein the nonionic surfactant is present in an amount of at least 2% by weight based on the composition.

8. The detergent composition according to claim 7, wherein the anionic surfactant is present in an amount of at least 2% by weight based on the composition.

9. The detergent composition according to claim 8, wherein the nonionic surfactant is present as granules having a mean particle size of from 100 to 1200 μm.

10. A process for the preparation of nonionic surfactant granules, said process comprising:
(a) providing a melt comprising at least one nonionic surfactant which is solid at room temperature; and
(b) passing the melt through a plate having at least one hole, wherein the plate is vibrating in a direction of its normal plane, such that droplets of from 100 to 1200 μm are formed.
